(19) United States
(12) Patent Application Publication
(10) Pub. No.: US 2026/0276210 A1
(43) Pub. Date: Sep. 17, 2026

(54) PM2.5 MEASUREMENT MODULE AND RANGE HOOD WITH SAME

(71) Applicant: GUANGDONG CHENGYI TECHNOLOGY CO., LTD, Foshan (CN)

(72) Inventors: Yong REN, Foshan (CN); Jie LI, Foshan (CN); Zhenzhou CEN, Foshan (CN)

(73) Assignee: GUANGDONG CHENGYI TECHNOLOGY CO., LTD, Foshan (CN)

(21) Appl. No.: 19/673,056

(22) Filed: May 11, 2026

Related U.S. Application Data
(63) Continuation of application No. PCT/CN2024/090647, filed on Apr. 29, 2024.

(30) Foreign Application Priority Data
Dec. 4, 2023 (CN) 202311647074.X

(51) Int. Cl. F24C 15/20; F24C 15/32

(52) U.S. Cl. CPC F24C 15/2092; F24C 15/2021; F24C 15/32

(57) ABSTRACT

A PM2.5 measurement module includes: a main body including a telescopic inner cavity enclosed by a frame assembly and a cover plate assembly, wherein a third measurement hole is provided in the bottom of the frame assembly; a telescopic panel assembly driven by a driving assembly and slidably connected into the telescopic inner cavity, wherein a first measurement hole is provided in the top of the telescopic panel assembly, and a second measurement hole is provided in the bottom of the telescopic panel assembly; and a PM2.5 measurement unit arranged in an installation cavity of the telescopic panel assembly.

### CROSS-REFERENCE TO RELATED APPLICATIONS

The present application is a continuation application of International Application No. PCT/CN2024/090647, filed on Apr. 29, 2024, which claims priority to Chinese Patent Application No. 202311647074.X, filed on Dec. 4, 2023. The disclosures of the above-mentioned applications are incorporated herein by reference in their entireties.

### TECHNICAL FIELD

The present application relates to the technical field of range hoods, and in particular to a PM2.5 measurement module and a range hood with the same.

### BACKGROUND

In daily life, range hoods have entered the kitchens of thousands of households, solving the problem of oil fume in the kitchen for users; with the improvement of living standards, the PM2.5 index has become a health indicator, and users' requirements for range hoods are not just basic oil fume removal. How to improve the intelligence of range hoods to ensure that cooking personnel are healthier has become an urgent problem to be solved. In order to save kitchen space, the existing range hoods are equipped with a telescopic panel assembly, and the PM2.5 measurement module is arranged on the telescopic panel assembly. When the user is cooking, the smoke exhaust fan of the range hood works, the telescopic panel assembly extends out of the telescopic inner cavity, and the PM2.5 measurement module extends out of the telescopic inner cavity with the telescopic panel assembly and detects the air quality of the cooking environment. However, after cooking, the telescopic panel assembly retracts out of the telescopic inner cavity, and the PM2.5 measurement module cannot detect the PM2.5 content in the ambient air. The user cannot get a prompt when oil fume flows back.

### SUMMARY

The purpose of the present application is to provide a particulate matter (PM) 2.5 measurement module and a range hood with the same, which are used to solve the above-mentioned technical problems.

A PM2.5 measurement module, applied to a range hood, including:
a main body, including a frame assembly and a cover assembly; the frame assembly and the cover assembly are connected to form a telescopic inner cavity, and a third measurement hole is provided at a bottom of the frame assembly;
a telescopic panel assembly, slidably connected in the telescopic inner cavity; a first measurement hole is provided at a top of the telescopic panel assembly, and a second measurement hole is provided at a bottom of the telescopic panel assembly;
a PM2.5 measurement unit, provided at an installation cavity of the telescopic panel assembly; and
a driving assembly, provided in the telescopic inner cavity; the driving assembly is connected to the telescopic panel assembly and configured to drive the telescopic panel assembly to extend out of or retract into the telescopic inner cavity;
when the telescopic panel assembly extends out of the telescopic inner cavity, the PM2.5 measurement unit is connected to an outside through the first measurement hole; when the telescopic panel assembly is retracted into the telescopic inner cavity, the PM2.5 measurement unit is communicated with the third measurement hole through the second measurement hole, and the third measurement hole is communicated with the outside.

In an embodiment, when the telescopic panel assembly extends out of the telescopic inner cavity, the third measurement hole is sealed, and the second measurement hole is sealed in the telescopic inner cavity; when the telescopic panel assembly retracts into the telescopic inner cavity, the first measurement hole is sealed, the second measurement hole is communicated with the third measurement hole, and the third measurement hole is communicated with the outside.

In an embodiment, a measurement hole switch assembly is provided in the telescopic inner cavity; when the telescopic panel assembly extends out of the telescopic inner cavity, the measurement hole switch assembly seals the third measurement hole; when the telescopic panel assembly retracts into the telescopic inner cavity, the measurement hole switch assembly opens the third measurement hole and communicates the third measurement hole with the second measurement hole.

In an embodiment, the measurement hole switch assembly includes a switch seat, an extension seat, a switch slider and an extension seat spring; the switch seat is provided with an air duct aligned with the third measurement hole; the extension seat is provided with an extension air duct sleeved with the air duct; the extension seat spring is provided between the extension seat and the switch seat; a switch slider spring is connected to a rear end of the switch slider; when the switch slider acts on the extension seat and seals the air duct, the extension seat spring is compressed; when the switch slider leaves the extension seat and opens the air duct, the switch slider spring is compressed, and the extension seat spring resets and drives the extension seat to move upward.

In an embodiment, the air duct includes an air inlet duct and an air exhaust duct, aligned with the third measurement hole at the same time; the extension air duct includes an air inlet extension duct sleeved with the air inlet duct and an air exhaust extension duct sleeved with the air exhaust duct; when the telescopic panel assembly retracts into the telescopic inner cavity and presses the switch slider backward, the switch slider leaves the extension seat and opens the air inlet duct and the air exhaust duct, and the extension seat spring resets and drives the air inlet extension duct and the air exhaust extension duct to slide upward along the air inlet duct and the air exhaust duct and abut against the second measurement hole.

In an embodiment, the PM2.5 measurement module further includes: a sealing assembly; the first measurement hole is located at a front side of the sealing assembly, and the second measurement hole is located at a rear side of the sealing assembly; the sealing assembly is configured for sealing at least a gap between a lower surface of the telescopic panel assembly and an opening of the telescopic inner cavity when the telescopic panel assembly extends out of the telescopic inner cavity.

In an embodiment, a measurement hole sealing assembly is provided in the telescopic inner cavity, and when the telescopic panel assembly is retracted into the telescopic inner cavity, the measurement hole sealing assembly seals the first measurement hole.

In an embodiment, the measurement hole sealing assembly includes a sealing seat, a sealing block and a sealing slider; the sealing seat is connected to a top of the telescopic inner cavity; the sealing block is connected to the sealing seat by sliding up and down; a sealing block spring is provided between the sealing block and the sealing seat; the sealing slider is connected to the sealing seat by sliding forward and backward; a sealing slider spring is connected to a rear end of the sealing slider; when the sealing slider acts on the sealing block, the sealing block spring is compressed; when the sealing slider leaves the sealing block, the sealing slider spring is compressed, and the sealing block spring resets and pushes the sealing block to move downward.

In an embodiment, the PM2.5 measurement unit includes a measurement shell and a PM2.5 measurement member arranged in the measurement shell; the measurement shell is provided with a measurement air intake duct and a measurement air exhaust duct independent of each other; upper end openings of the measurement air intake duct and the measurement air exhaust duct are abutted against a top surface of the telescopic panel assembly and aligned with the first measurement hole; lower end openings of the measurement air intake duct and the measurement air exhaust duct are abutted against a bottom surface of the telescopic panel assembly and aligned with the second measurement hole; an air intake side of the PM2.5 measurement member is in communication with the measurement air intake duct; and an air exhaust side of the PM2.5 measurement member is in communication with the measurement air exhaust duct.

A range hood, including the PM2.5 measurement module; an air collecting box assembly is further provided in the main body, and a smoke exhaust fan is provided in the air collecting box assembly; the smoke exhaust fan, the PM2.5 measurement unit and the driving assembly are connected to a control system of the range hood, and the control system enables the smoke exhaust fan and the PM2.5 measurement unit to operate in linkage.

Compared with the related art, the PM2.5 measurement module of the present application has the following advantages.

In the PM2.5 measurement module of the present application, when the telescopic panel assembly extends out of the telescopic inner cavity, the PM2.5 measurement unit is connected with the outside through the first measurement hole, and the external air can enter the PM2.5 measurement unit through the first measurement hole. The PM2.5 measurement unit detects the PM2.5 content in the air in the cooking environment in real time to clearly understand the purification effect of the smoke exhaust fan on the oil fume when the range hood is working, so that the user can have a healthy cooking environment; when the telescopic panel assembly is retracted into the telescopic inner cavity, the PM2.5 measurement unit is connected with the third measurement hole through the second measurement hole, and the third measurement hole is connected with the outside. The PM2.5 measurement unit continues to detect the PM2.5 content in the ambient air, which can avoid the backflow of oil fume without being noticed by the user, thereby ensuring the quality of ambient air.

### BRIEF DESCRIPTION OF THE DRAWINGS

FIG. 1 is an exploded diagram of a range hood having a PM2.5 measurement module of the present application.

FIG. 2 is a schematic structural diagram of a telescopic panel assembly in FIG. 1 from another direction.

FIG. 3 is an exploded diagram of the PM2.5 measurement unit in FIG. 1.

FIG. 4 is a schematic structural diagram of the measurement hole switch assembly in FIG. 1.

FIG. 5 is an exploded diagram of the measurement hole switch assembly in FIG. 4.

FIG. 6 is a schematic structural diagram of the measurement hole sealing assembly in FIG. 1.

FIG. 7 is an exploded diagram of the measurement hole sealing assembly in FIG. 6

FIG. 8 is a cross-sectional diagram of the telescopic panel assembly of the range hood having the PM2.5 measurement module of the present application after being retracted into the telescopic inner cavity.

FIG. 9 is a cross-sectional diagram of the telescopic panel assembly of the range hood having the PM2.5 measurement module of the present application after extending out of the telescopic inner cavity.

FIG. 10 is a partial enlarged diagram of A in FIG. 8.

FIG. 11 is a partial enlarged diagram of B in FIG. 9.

The realization of the functions and advantages of the present application will be further explained in conjunction with the embodiments and with reference to the accompanying drawings.

### DETAILED DESCRIPTION OF THE EMBODIMENTS

The following will disclose multiple embodiments of the present application with drawings. For the purpose of clear description, many practical details will be described together in the following description. However, it should be understood that these practical details should not be used to limit the present application. In other words, in some embodiments of the present application, these practical details are not necessary. In addition, in order to simplify the drawings, some conventional structures and assemblies will be depicted in a simple schematic manner in the drawings.

It should be noted that all directional indications in the embodiments of the present application (such as up, down, left, right, front, back, etc.) are only used to explain the relative position relationship, movement status, etc. between the assemblies under a certain specific posture (as shown in the accompanying drawings). If the specific posture changes, the directional indication will also change accordingly.

In addition, in the present application, the descriptions of “first”, “second”, etc. are only used for descriptive purposes, and do not specifically refer to the order or sequence, nor are they used to limit the present application. They are only used to distinguish assemblies or operations described with the same technical terms, and cannot be understood as indicating or implying their relative importance or implicitly indicating the number of technical features indicated. Therefore, the features defined as “first” and “second” may explicitly or implicitly include at least one of the features. In addition, the technical solutions between the various embodiments can be combined with each other, but they must be based on the ability of those skilled in the art to implement them. When the combination of technical solutions is contradictory or cannot be implemented, it should be deemed that such a combination of technical solutions does not exist and is not within the protection scope required by the present application.

In order to further understand the content, features and effects of the present application, the following embodiments are given as examples and described in detail with reference to the accompanying drawings:

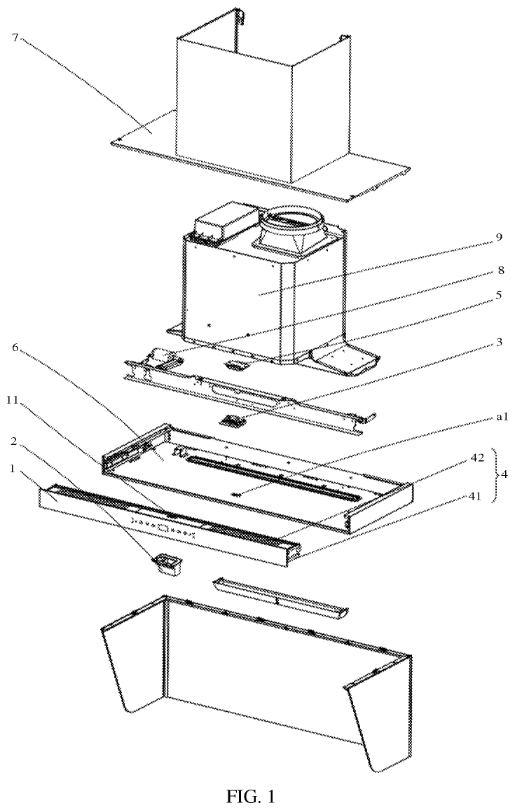

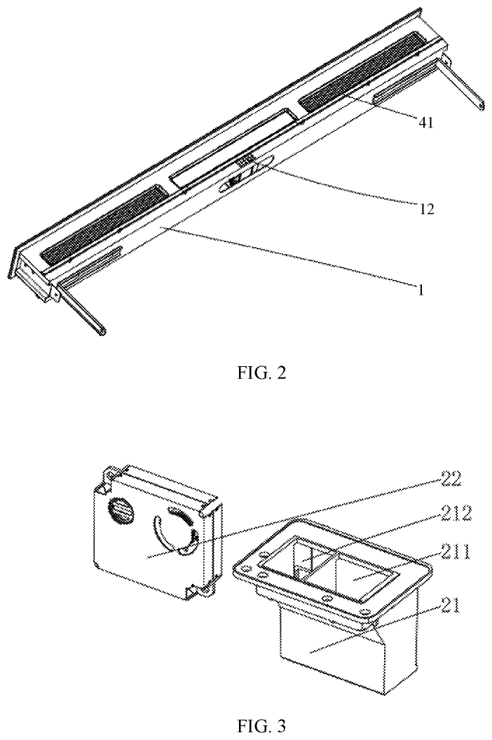

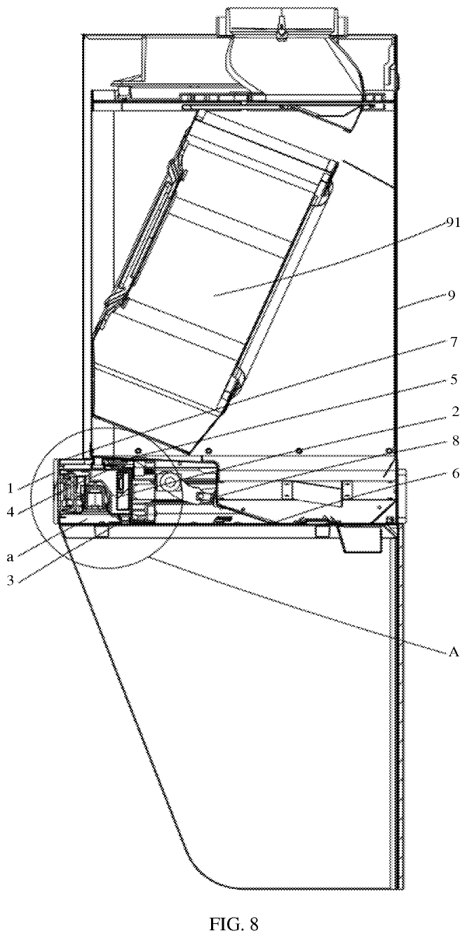

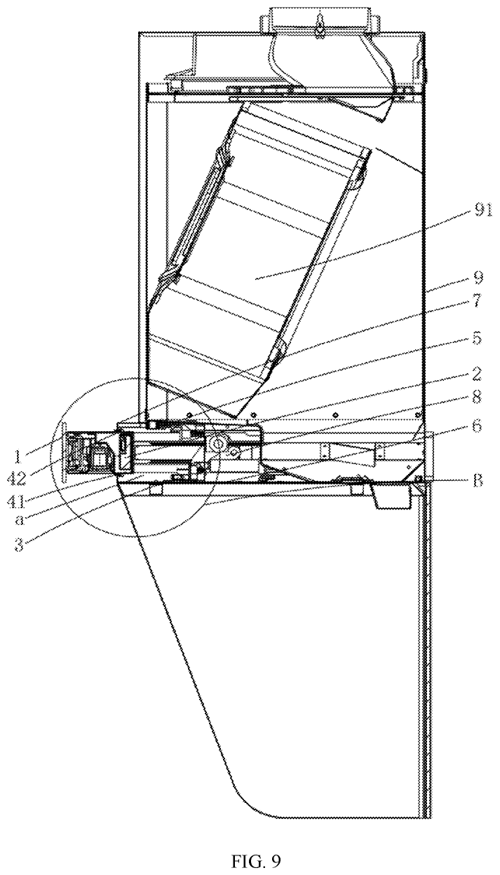

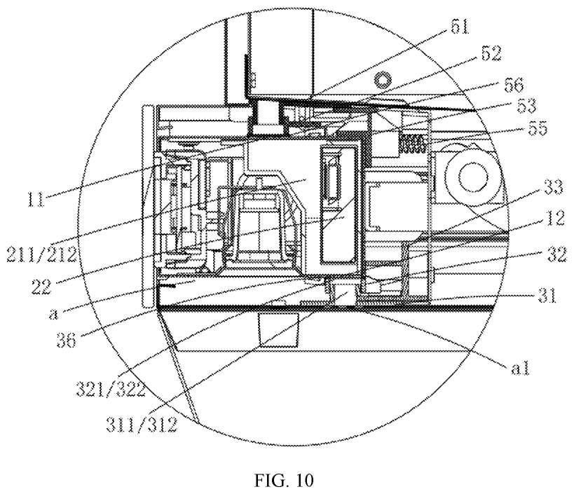

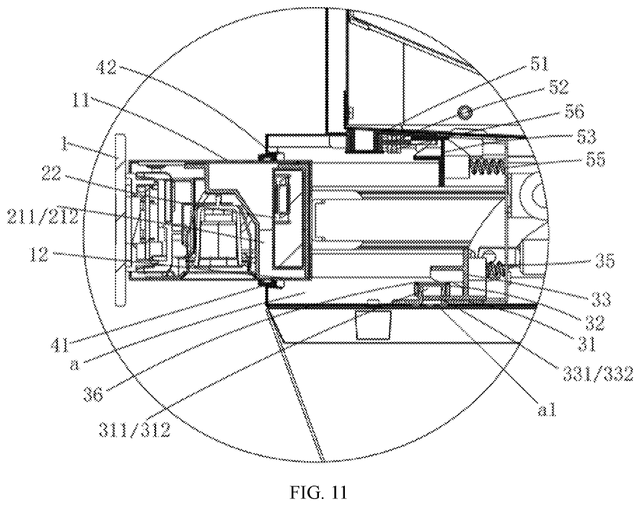

Please refer to FIGS. 1 to 11, the present application discloses a PM2.5 measurement module. The PM2.5 measurement module disclosed in the present application is used for a range hood, including a main body, a telescopic panel assembly 1, a PM2.5 measurement unit 2 and a driving assembly 8. The main body includes a frame assembly 6 and a cover assembly 7. The frame assembly 6 is connected to the cover assembly 7 and encloses a telescopic inner cavity a. A third measurement hole a1 is provided at the bottom of the frame assembly 6; the telescopic panel assembly 1 is slidably connected to the telescopic inner cavity a; a first measurement hole 11 is provided at the top thereof, and a second measurement hole 12 is provided at the bottom thereof.

The PM2.5 measurement unit 2 is arranged in the installation cavity of the telescopic panel assembly 1; the driving assembly 8 is arranged in the telescopic inner cavity a, and the driving assembly 8 is connected to the telescopic panel assembly 1 and used to drive the telescopic panel assembly 1 to extend or retract the telescopic inner cavity a; when the telescopic panel assembly 1 extends out of the telescopic inner cavity a, the PM2.5 measurement unit 2 is connected to the outside through the first measurement hole 11; when the telescopic panel assembly 1 retracts into the telescopic inner cavity a, the PM2.5 measurement unit 2 is connected to the third measurement hole a1 through the second measurement hole 12, and the third measurement hole a1 is connected to the outside.

The PM2.5 measurement module of the present application, when applied to the range hood, when the range hood is working, the driving assembly 8 drives the telescopic panel assembly 1 to extend out from the telescopic inner cavity a; the first measurement hole 11 is connected to the outside, and the external air can enter the PM2.5 measurement unit 2 through the first measurement hole 11 and be detected by the PM2.5 measurement unit 2. Through the M2.5 content value detected by the PM2.5 measurement unit 2, the user can clearly understand the purification effect of the range hood on the oil fume; when the PM2.5 measurement unit 2 is linked with the control system of the range hood, and when the PM2.5 content detected by the PM2.5 measurement unit 2 exceeds the standard, the control system of the range hood automatically increases the power of the smoke exhaust fan of the range hood to extract and discharge the oil fume as quickly as possible to reduce the PM2.5 content in the air of the cooking environment, so that the user has a healthy cooking environment; after the user finishes cooking, the smoke exhaust fan of the range hood is turned off, and the driving assembly 8 drives the smoke exhaust fan to turn off.

The telescopic panel assembly 1 retracts the telescopic inner cavity a, and the PM2.5 measurement unit 2 is connected with the third measurement hole a1 through the second measurement hole 12. The third measurement hole a1 is connected with the outside. The external air can enter the second measurement hole 12 through the third measurement hole a1, and then enter the PM2.5 measurement unit 2 through the second measurement hole 12. The PM2.5 measurement unit 2 continues to detect the PM2.5 content in the ambient air outside the telescopic inner cavity a, which can avoid the backflow of oil smoke without being noticed by the user, thereby ensuring the quality of ambient air; when the PM2.5 content in the air outside the telescopic inner cavity a detected by the PM2.5 measurement unit 2 exceeds the standard, the control system of the range hood will start the smoke exhaust fan of the range hood again, and make the smoke exhaust fan draw air in the environment. When the PM2.5 content in the ambient air detected by the PM2.5 measurement unit 2 reaches the standard value, the control system of the range hood will turn off the smoke exhaust fan again.

Please refer to FIG. 1, in the PM2.5 measurement module of the present application, when the telescopic panel assembly 1 extends out of the telescopic inner cavity a, the third measurement hole a1 is sealed, and the second measurement hole 12 is sealed in the telescopic inner cavity a; when the telescopic panel assembly 1 retracts into the telescopic inner cavity a, the first measurement hole 11 is sealed, the second measurement hole 12 is connected to the third measurement hole a1, and the third measurement hole a1 is connected to the outside. When used for a range hood, when the smoke exhaust fan of the range hood is started, the driving assembly 8 drives the telescopic panel assembly 1 to extend out of the telescopic inner cavity a. The fumes generated when the user cooks are located below the telescopic panel assembly 1.

If the third measurement hole a1 is in an open state, the fumes generated by cooking will enter the second measurement hole 12 through the third measurement hole a1 and then be detected by the PM2.5 measurement unit 2. The measurement result of the PM2.5 measurement unit 2 cannot represent the purification effect of the smoke exhaust fan. Therefore, when the telescopic panel assembly 1 extends out of the telescopic inner cavity a, the third measurement hole a1 is sealed and the second measurement hole 12 is sealed in the telescopic inner cavity a. The fumes generated by cooking cannot enter the PM2.5 measurement unit 2 through the third measurement hole a1 and the second measurement hole 12. The air detected by the PM2.5 measurement unit 2 comes from the external air entering through the first measurement hole 11, which is the clean air when the range hood is working. The PM2.5 content value in the air after cooking can actually reflect the air quality of the cooking environment and provide a basis for the control system of the range hood to control the power of the smoke exhaust fan; and after the driving assembly 8 drives the telescopic panel assembly 1 to retract into the telescopic inner cavity a, the first measurement hole 11 is sealed, the third measurement hole a1 is connected to the outside; and the second measurement hole 12 is connected to the third measurement hole a1. The air detected by the PM2.5 measurement unit 2 comes from the air of the environment outside the telescopic inner cavity a. The PM2.5 content value in the air is the PM2.5 content in the ambient air after the range hood is turned off. When the user is not cooking and the PM2.5 content in the ambient air exceeds the standard, it indicates that there is a possibility of backflow of oil smoke, or other factors affect the ambient air quality. At this time, the control system of the range hood will start the smoke exhaust fan of the range hood again and make the smoke exhaust fan purify the ambient air.

Please refer to FIGS. 1, 8 and 9, in the PM2.5 measurement module of the present application, a measurement hole switch assembly 3 is provided in the telescopic inner cavity a. When the telescopic panel assembly 1 extends out of the telescopic inner cavity a, the measurement hole switch assembly 3 seals the third measurement hole a1. When the telescopic panel assembly 1 retracts into the telescopic inner cavity a, the measurement hole switch assembly 3 opens the third measurement hole a1 and connects the third measurement hole a1 with the second measurement hole 12. When the telescopic panel assembly 1 retracts into the telescopic inner cavity, if the measurement hole switch assembly 3 only opens the third measurement hole a1, and does not directly connect the third measurement hole a1 with the second measurement hole 12, when the PM2.5 measurement unit 2 is started, the PM2.5 measurement unit 2 first draws the air in the telescopic inner cavity a. It takes a certain amount of time for the external air to enter the telescopic inner cavity through the third measurement hole a1. The measurement result of the PM2.5 measurement unit 2 has a lag and may have errors compared with the measurement result when the PM2.5 detector is directly used to detect the air quality in the environment; in order to make the PM2.5 measurement unit 2 can still detect the ambient air quality in real time when the telescopic panel assembly 1 retracts into the telescopic inner cavity a. The PM2.5 measurement module of the present application is provided with a measurement hole switch assembly 3 that directly connects the third measurement hole a1 and the second measurement hole 12. In this way, when the PM2.5 measurement unit 2 is started, the external air enters the measurement hole switch assembly 3 through the third measurement hole a1, and then enters the second measurement hole 12 through the measurement hole switch assembly 3, and then enters the PM2.5 measurement unit 2 from the second measurement hole 12 and is detected. The PM2.5 measurement unit 2 detects the air outside the telescopic inner cavity a when the telescopic panel assembly 1 retracts into the telescopic inner cavity a. The measurement result truly reflects the ambient air quality.

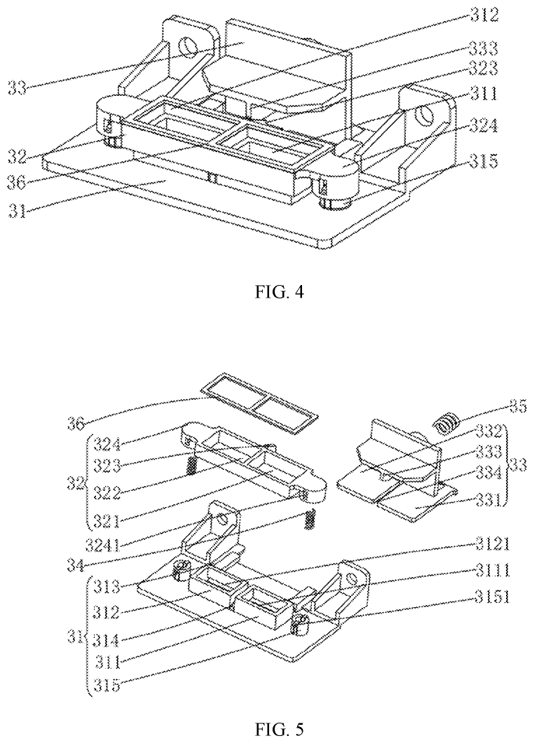

Please refer to FIGS. 4, 5, 8 to 11, in the PM2.5 measurement module of the present application, the measurement hole switch assembly 3 includes a switch seat 31, an extension seat 32, a switch slider 33 and an extension seat spring 34. The switch seat 31 is provided with an air duct aligned with the third measurement hole a1, the extension seat 32 is provided with an extension air duct sleeved to the air duct; an extension seat spring 34 is provided between the extension seat 32 and the switch seat 31, and the rear end of the switch slider 33 is connected to the switch slider spring 35; when the switch slider 33 acts on the extension seat 32 and seals the air duct, the extension seat spring 34 is compressed; when the switch slider 33 leaves the extension seat 32 and opens the air duct, the switch slider spring 35 is compressed, the extension seat spring 34 resets and drives the extension seat 32 to move upward. When the telescopic panel assembly 1 moves into the telescopic inner cavity a, the rear wall of the telescopic panel assembly 1 acts on the switch slider 33 and pushes the switch slider 33 to move away from the user side. When the switch slider 33 moves away from the user side, the switch slider 33 opens the air duct, and at the same time, the switch slider 33 compresses the switch slider spring 35 backwards. After the telescopic panel assembly 1 is completely retracted into the telescopic inner cavity a, the switch slider 33 completely leaves the extension seat 32, and the air duct on the switch seat 31 is opened. The extension seat 32 moves upward under the action of the extension seat spring 34, so that the extension air duct rises along the air duct and abuts against the bottom of the telescopic panel assembly 1, and the extension air duct is aligned with the second measurement hole 12. At this time, the third measurement hole a1, the air duct, the extension air duct and the second measurement hole 12 are connected in sequence, and the external air passes through the third measurement hole a1, the air duct, the extension air duct and the second measurement hole 12 in sequence and enters the PM2.5 measurement unit 2; when the telescopic panel assembly 1 extends out of the telescopic inner cavity a, the action of the rear wall of the telescopic panel assembly 1 on the switch slider 33 disappears, the switch slider spring 35 resets and pushes the switch slider 33 to move toward the user side; the switch slider 33 acts on the extension seat 32 again and presses the extension seat 32 downward, the extension seat spring 34 is compressed; and when the telescopic panel assembly 1 is fully extended out of the telescopic inner cavity a, the extension seat spring 34 is fully reset, and the switch slider 33 seals the air duct.

Please refer to FIGS. 4, 5, 8 to 11, in the PM2.5 measurement module of the present application, the air duct includes an air intake duct 311 and an air exhaust duct 312 which are aligned with the third measurement hole a1 at the same time, and the extension air duct includes an air intake extension duct 321 and an air exhaust extension duct 322 which are respectively connected to the air intake duct 311 and the air exhaust duct 312. When the telescopic panel assembly 1 retracts into the telescopic inner cavity a and squeezes the switch slider 33 backward, the switch slider 33 leaves the extension seat 32 and opens the air intake duct 311 and the air exhaust duct 312, and the extension seat spring 34 resets and drives the air intake extension duct 321 and the air exhaust extension duct 322 to slide upward along the air intake duct 311 and the air exhaust duct 312 and abut against the second measurement hole 12. The air duct is divided into an air intake duct 311 and an air exhaust duct 312, and the extension air duct is divided into an air intake extension duct 321 and an air exhaust extension duct 322. The air intake duct 311 is connected to the air intake extension duct 321, and the air exhaust duct 312 is connected to the air exhaust extension duct 322. When the switch slider 33 leaves the extension seat 32, its extension air duct moves upward and abuts against the bottom of the telescopic panel assembly 1, the air intake extension duct 321 is aligned with part of the second measurement hole 12, and the air exhaust extension duct 322 is aligned with another part of the second measurement hole 12. In this way, when the PM2.5 measurement unit 2 is working, part of the air enters the air intake duct 311 through the part of the third measurement hole a1 that is aligned with the air intake duct 311, flows along the air intake duct 311 and enters the air intake extension duct 322. 1, then enters the second measurement hole 12 and the part aligned with the air intake extension duct 321 through the air intake extension duct 321, then enters the PM2.5 measurement unit 2 through the second measurement hole 12, and after being detected by the PM2.5 measurement unit 2, it is discharged into the air exhaust extension duct 322 through the air exhaust extension duct 322 and the part aligned with the second measurement hole 12, and then enters the air exhaust duct 312 through the air exhaust extension duct 322, and finally discharged from the part aligned with the air exhaust duct 312 through the third measurement hole a1, which can separate the duct of the airflow entering the PM2.5 measurement unit 2 from the duct of the airflow discharged from the PM2.5 measurement unit 2, so that the PM2.5 measurement unit 2 detects the real-time ambient air, and the measurement result is more meaningful for reference. When the telescopic panel assembly 1 extends out of the telescopic inner cavity a, the switch slider spring 35 pushes the switch slider 33 to move toward the user side, and presses the extension seat 32 downward, and the extension air duct moves downward along the air duct and leaves the bottom of the telescopic panel assembly 1. When the telescopic panel assembly 1 leaves the telescopic inner cavity a, it will not interfere with the movement of the telescopic panel assembly 1.

Please refer to FIGS. 4, 5, 8 to 11, in the PM2.5 measurement module of the present application, the rear wall surface of the air intake duct 311 is provided with a first notch 3111, and the rear wall surface of the air exhaust duct 312 is provided with a second notch 3121; the front wall surface of the switch slider 33 is provided with a first sealing plate 331, a second sealing plate 332 and a first starting member 333 extending forward; when the switch slider 33 acts on the extension seat 32, the first sealing plate 331 extends into the air intake duct 311 through the first notch 3111 and seals the air intake duct 311; and the second sealing plate 332 enters the air exhaust duct 312 through the second notch 3121 and seals the air exhaust duct 312, and the first starting member 333 acts on the extension seat 32 and compresses the extension seat spring 34; when the switch slider 33 is pushed and moved by the rear side wall of the telescopic panel assembly 1 facing away from the user side, the first starting member 333 leaves the extension seat 32, and the first sealing plate 331 and the second sealing plate 332 withdraw from the air intake duct 311 and the air exhaust duct 312; the switch slider spring 35 is compressed, and the extension seat spring 34 resets and drives the air intake extension duct 321 and the air exhaust extension duct 322 to slide upward. When the telescopic panel assembly 1 extends out of the telescopic inner cavity a, the switch slider spring 35 resets and pushes the switch slider 33 to move toward the user side, so that the switch slider 33 acts on the extension seat 32; the first sealing plate 331 extends into the air intake duct 311 through the first notch 3111 and seals the air intake duct 311, and the second sealing plate 332 enters the air exhaust duct 312 through the second notch 3121 and seals the air exhaust duct 312; the first starting member 333 acts on the extension seat 32 and compresses the extension seat spring 34. At this time, after the external air passes through the third measurement hole a1 and enters the air intake duct 311, it cannot continue to flow along the air intake duct 311 to the air intake extension duct 321; when the telescopic panel assembly 1 retracts into the telescopic inner cavity a, the rear wall surface of the telescopic panel assembly 1 acts on the switch slider 33 and applies a force away from the user side to the switch slider 33, the switch slider 33 is driven and retreats; the first starting member 333 leaves the extension seat 32; the first sealing plate 331 and the second sealing plate 332 withdraw from the air intake duct 311 and the air exhaust duct 312; the switch slider spring 35 is compressed, and the extension seat spring 34 resets. The air inlet extension duct 321 and the air exhaust extension duct 322 are driven to slide upward along the air inlet duct 311 and the air exhaust duct 312, and the air inlet extension duct 321 and the air exhaust extension duct 322 abut against the bottom plate of the telescopic panel assembly 1 and are aligned with the second measurement hole 12 on the bottom plate of the telescopic panel assembly 1. When the PM2.5 measurement unit 2 located in the installation cavity of the telescopic panel assembly 1 is working, the external air enters the air inlet duct 311 through the third measurement hole a1 at the bottom of the telescopic inner cavity a and the part aligned with the air inlet duct 311, and then enters the air inlet extension duct 311 along the air inlet duct 311, flows along the air intake extension duct 321 and enters the PM2.5 measurement unit 2 through the second measurement hole 12 at the bottom of the telescopic panel assembly 1 that is aligned with the air intake extension duct 321. After being detected by the PM2.5 measurement unit 2, it enters the air exhaust extension duct 322 through the second measurement hole 12 at the bottom of the telescopic panel assembly 1 that is aligned with the air exhaust extension duct 322, flows along the air exhaust extension duct 322, enters the air exhaust duct 312 through the air exhaust extension duct 322, and is finally discharged from the third measurement hole a1 at the bottom of the telescopic inner cavity a that is aligned with the air exhaust duct 312.

Please refer to FIG. 4 and FIG. 5, in the PM2.5 measurement module of the present application, the rear wall of the extension seat 32 is provided with a second starting member 323. The second starting member 323 has an inclined surface facing the switch slider 33. The inclined surface is inclined downward from the side away from the switch slider 33 to the side close to the switch slider 33. The first starting member 333 has an inclined surface facing the second starting member 323, and the inclined surface on the first starting member 333 is opposite to the inclined surface on the second starting member 323. When the telescopic panel assembly 1 extends out of the telescopic inner cavity a, the force of the rear wall of the telescopic panel assembly 1 on the switch slider 33 disappears. When the switch slider spring 35 resets and pushes the switch slider 33 to slide toward the user side, the inclined surface of the first starting member 333 slides along the inclined surface of the second starting member 323 and moves the extension seat 32 downward. The extension seat 32 leaves the bottom of the telescopic panel assembly 1 and compresses the extension seat spring 34 downward.

Please refer to FIGS. 4 and 5, in the PM2.5 measurement module of the present application, the left and right sides of the switch seat 31 are provided with first front and rear slide grooves 313, and the outer sides of the first sealing plate 331 and the second sealing plate 332 are respectively slidably connected to the first front and rear slide grooves 313 on the corresponding sides. When the telescopic panel assembly 1 extends out of the telescopic inner cavity a, the force exerted by the telescopic panel assembly 1 on the switch slider 33 disappears; and when the switch slider spring 35 resets and pushes the switch slider 33 to slide toward the user side, the first sealing plate 331 and the second sealing plate 332 slide along the first front and rear slide grooves 313 on the corresponding sides, which can avoid the movement direction of the switch slider 33 from being offset, and ensure the linear movement of the switch slider 33.

Please refer to FIGS. 4 and 5, in the PM2.5 measurement module of the present application, a front and rear guide groove 334 is formed between the first sealing plate 331 and the second sealing plate 332. The switch seat 31 is provided with a front and rear guide block 314 located between the air intake duct 311 and the air exhaust duct 312. The front and rear guide block 314 is slidably connected in the front and rear guide groove 334. When the telescopic panel assembly 1 extends out of the telescopic inner cavity a, the force exerted on the switch slider 33 by the rear wall of the telescopic panel assembly 1 disappears. When the switch slider spring 35 resets and pushes the switch slider 33 to slide toward the user side, the first sealing plate 331 and the second sealing plate 332 slide along the first front and rear slide groove 313 on the corresponding side and at the same time, the front and rear guide block 314 slides along the front and rear guide groove 334, which can avoid the movement direction of the switch slider 33 from being offset and ensure the linear movement of the switch slider 33. And because the air intake duct 311 and the air exhaust duct 312 are independent of each other, a front and rear guide groove 334 must be formed between the first sealing plate 331 and the second sealing plate 332, so that the first sealing plate 331 and the second sealing plate 332 can seal or open the air intake duct 311 and the air exhaust duct 312 respectively.

Please refer to FIG. 4 and FIG. 5, in the PM2.5 measurement module of the present application, the extension seat 32 is provided with extension seat spring slide grooves 324 on both sides; the switch seat 31 is provided with an extension seat spring seat 315 corresponding to the extension seat spring slide grooves 324; the extension seat spring 34 is connected in the extension seat spring seat 315, and the extension seat spring seat 315 is slidably connected in the extension seat spring slide grooves 324. When the switch slider 33 acts on the extension seat 32, the air intake extension duct 321 and the air exhaust extension duct 322 slide downward along the air intake duct 311 and the air exhaust duct 312; the extension seat spring slide groove 324 slides along the extension seat spring seat 315 and compresses the extension seat spring 34 downward, and under the limiting action of the extension seat spring slide groove 324 and the extension seat spring seat 315, the extension seat spring 34 can only be deformed in the vertical direction in the lower extension seat spring slide groove 324 and the extension seat spring seat 315, but cannot be twisted.

Please refer to FIGS. 4 and 5, in the PM2.5 measurement module of the present application, an extension seat limit groove 3241 is provided at the side wall of the extension seat spring slide groove 324, and an extension seat limit block 3151 is provided at the extension seat spring seat 315. The extension seat limit block 3151 is slidably connected in the extension seat limit groove 3241. When the switch slider 33 acts on the extension seat 32, the air intake extension duct 321 and the air exhaust extension duct 322 slide downward along the air intake duct 311 and the air exhaust duct 312; the air intake extension duct 321 and the air exhaust extension duct 322 slide downward along the air intake duct 311 and the air exhaust duct 312; the extension seat limit block 3151 slides along the extension seat limit groove 3241, and the extension seat spring 34 is compressed; after the switch slider 33 leaves the extension seat 32, the extension seat spring 34 resets, the extension seat spring 34 pushes the extension seat 32 to move upward, and the extension seat limit block 3151 limits the extension seat spring slide groove 324 through the extension seat limit groove 3241 to prevent the extension seat spring slide groove 324 from detaching from the extension seat spring seat 315.

Please refer to FIGS. 4 and 5, in the PM2.5 measurement module of the present application, a first sealing sponge 36 is provided at the side of the extension seat 32 away from the switch seat 31. The first sealing sponge 36 is provided with openings corresponding to the air intake extension duct 321 and the air exhaust extension duct 322. After the switch slider 33 leaves the extension seat 32, the extension seat spring 34 resets and pushes the extension seat 32 to move upward. When the air intake extension duct 321 and the air exhaust extension duct 322 move upward along the air intake duct 311 and the air exhaust duct 312 and act on the bottom surface of the telescopic panel assembly 1, the first sealing sponge 36 is squeezed between the extension seat 32 and the bottom surface of the telescopic panel assembly 1, and the gap between the extension seat 32 and the bottom surface of the telescopic panel assembly 1 is sealed, so that the intake air can only enter the second measurement hole 12 on the bottom surface of the telescopic panel assembly 1 through the air intake extension duct 321, and the exhaust of the PM2.5 measurement unit 2 can only enter the air exhaust extension duct 322 through the second measurement hole 12 on the bottom surface of the telescopic panel assembly 1 that is aligned with the air exhaust extension duct 322, and then be discharged through the air exhaust extension duct 322, the air exhaust duct 312 and the third measurement hole a1 at the bottom of the telescopic inner cavity in turn.

Please refer to FIGS. 1, 2, 8 to 11, the PM2.5 measurement module of the present application also includes a sealing assembly 4. The first measurement hole 11 is located at the front side of the sealing assembly 4, and the second measurement hole 12 is located at the rear side of the sealing assembly 4. The sealing assembly 4 is used to seal the gap between the lower surface of the telescopic panel assembly 1 and the opening of the telescopic inner cavity a when the telescopic panel assembly 1 extends out of the telescopic inner cavity a. The gap between the lower surface of the telescopic panel assembly 1 and the opening of the telescopic inner cavity a faces the cooking stove. When the oil smoke moves toward the air intake of the hood, the escaping oil smoke may enter the telescopic inner cavity a through the gap between the lower surface of the telescopic panel assembly 1 and the opening of the telescopic inner cavity a. The sealing assembly 4 is provided to seal the gap between the lower surface of the telescopic panel assembly 1 and the opening of the telescopic inner cavity a, so as to prevent the oil smoke from entering the telescopic inner cavity a through the gap between the lower surface of the telescopic panel assembly 1 and the opening of the telescopic inner cavity a. In this embodiment, the sealing assembly 4 includes a first sealing strip 41, which is located on the lower wall surface of the telescopic panel assembly 1, and the second measurement hole 12 is located on the rear side of the first sealing strip 41. After the telescopic panel assembly 1 extends out of the telescopic inner cavity a, the first sealing strip 41 is squeezed by the lower edge of the opening of the telescopic inner cavity a, and the first sealing strip 41 is squeezed between the lower wall surface of the telescopic panel assembly 1 and the lower edge of the opening of the telescopic inner cavity a, thereby sealing the gap between the lower surface of the telescopic panel assembly 1 and the opening of the telescopic inner cavity a.

In an embodiment, when the telescopic panel assembly 1 extends out of the telescopic inner cavity a, the sealing assembly 4 seals the front opening of the telescopic inner cavity a, and the fumes generated when the user cooks will not enter the telescopic inner cavity a through the gap between the opening of the telescopic inner cavity a and the telescopic panel assembly 1, and will not pollute the telescopic inner cavity a. The sealing assembly 4 includes a first sealing strip 41 and a second sealing strip 42. The first sealing strip 41 is located on the lower wall of the telescopic panel assembly 1, and the second measurement hole 12 is located on the rear side of the first sealing strip 41; the second sealing strip 42 is located on the upper wall of the telescopic panel assembly 1, and the first measurement hole 11 is located on the front side of the second sealing strip 42. After the telescopic panel assembly 1 extends out of the telescopic inner cavity a, the first measurement hole 11 is located outside the telescopic inner cavity a; the first sealing strip 41 is squeezed by the lower edge of the opening of the telescopic inner cavity a, and the first sealing strip 41 is squeezed between the lower wall of the telescopic panel assembly 1 and the lower edge of the opening of the telescopic inner cavity a; the second sealing strip 42 is squeezed by the upper edge of the opening of the telescopic inner cavity a, and the second sealing strip 42 is squeezed between the upper wall of the telescopic panel assembly 1 and the upper edge of the opening of the telescopic inner cavity a, thereby sealing the gap between the telescopic panel assembly 1 and the opening of the telescopic inner cavity a.

Please refer to FIGS. 1, 8 to 11, in the PM2.5 measurement module of the present application, a measurement hole sealing assembly 5 is provided in the telescopic inner cavity a. When the telescopic panel assembly 1 is retracted into the telescopic inner cavity a, the measurement hole sealing assembly 5 seals the first measurement hole 11. When the telescopic panel assembly 1 is retracted into the telescopic inner cavity a, the first measurement hole 11 enters the telescopic inner cavity a. If the first measurement hole 11 is not sealed, when the PM2.5 measurement unit 2 is working, the air in the telescopic inner cavity a will enter the PM2.5 measurement unit 2 through the first measurement hole 11. At this time, the air detected by the PM2.5 measurement unit 2 includes both the air in the telescopic inner cavity a and the external air that enters through the third measurement hole a1, the air intake duct 311, the air intake extension duct 321 and the second measurement hole 12 in sequence. The air quality cannot represent the external air quality. Therefore, when the telescopic panel assembly 1 retracts into the telescopic inner cavity a, the measurement hole sealing assembly 5 seals the first measurement hole 11, and only external air can enter the PM2.5 measurement unit 2 through the third measurement hole a1, the air intake duct 311, the air intake extension duct 321 and the second measurement hole 12. The measurement value of the PM2.5 measurement unit 2 can represent the external air quality.

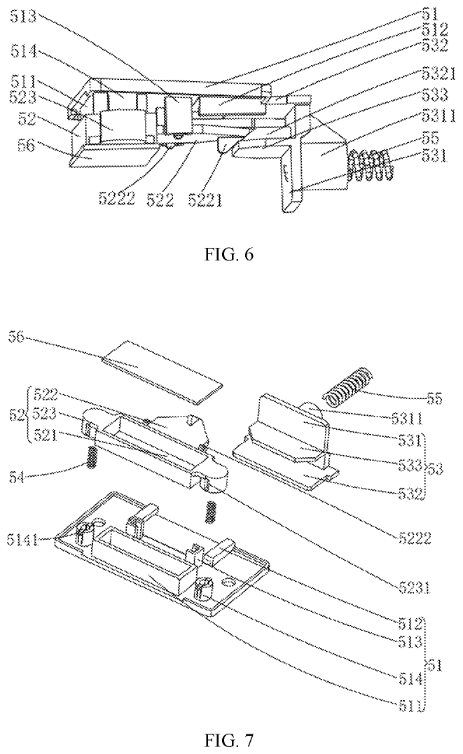

Please refer to FIGS. 6 to 11, in the PM2.5 measurement module of the present application, the measurement hole sealing assembly 5 includes a sealing seat 51, a sealing block 52 and a sealing slider 53. The sealing seat 51 is connected to the top of the telescopic inner cavity aa, n d the sealing block 52 is connected to the sealing seat 51 by sliding up and down; a sealing block spring 54 is provided between the sealing block 52 and the sealing seat 51; the sealing slider 53 is connected to the sealing seat 51 by sliding back and forth, and the rear end of the sealing slider 53 is connected to the sealing slider spring 55; when the sealing slider 53 acts on the sealing block 52, the sealing block spring 54 is compressed; when the sealing slider 53 leaves the sealing block 52, the sealing slider spring 55 is compressed, and the sealing block spring 54 resets and pushes the sealing block 52 to move downward. When the telescopic panel assembly 1 extends out of the telescopic inner cavity a, the first measurement hole 11 at the top of the telescopic panel assembly 1 extends out of the telescopic inner cavity a, and the external air enters the PM2.5 measurement unit 2 through the first measurement hole 11 at the top of the telescopic panel assembly 1 and is detected by the PM2.5 measurement unit 2; when the telescopic panel assembly 1 is retracted into the telescopic inner cavity a, the rear wall surface of the telescopic panel assembly 1 acts on the sealing slider 53 and moves the sealing slider 53 away from the user side; the sealing slider 53 leaves the sealing block 52, and the sealing block spring 54 resets and pushes the sealing block 52 to move downward. When the telescopic panel assembly 1 retracts into place in the telescopic inner cavity a, the sealing block spring 54 is completely reset and presses the sealing block 52 against the top of the telescopic panel assembly 1. The sealing block 52 seals the first measurement hole 11 at the top of the telescopic panel assembly 1. The air in the telescopic inner cavity a cannot enter the PM2.5 measurement unit 2 in the telescopic panel assembly 1 through the first measurement hole 11 at the top of the telescopic panel assembly 1, thereby preventing the air detected by the PM2.5 measurement unit 2 from being mixed with the air in the telescopic inner cavity a, so that the measurement result of the PM2.5 measurement unit 2 can truly feedback the external air quality.

Please refer to FIGS. 6 and 7, in the PM2.5 measurement module of the present application, the sealing seat 51 of the measurement hole sealing assembly 5 is provided with a first upper and lower guide block 511 and a second front and rear slide groove 512, and the sealing block 52 is provided with an upper and lower guide groove 521. The first upper and lower guide block 511 is slidably connected to the upper and lower guide groove 521, and the sealing slider 53 is slidably connected to the second front and rear slide groove 512. When the telescopic panel assembly 1 retracts into the telescopic inner cavity a, the rear wall surface of the telescopic panel assembly 1 acts on the sealing slider 53 and drives the sealing slider 53 to move away from the user side along the second front and rear slide groove 512; the sealing slider 53 leaves the sealing block 52, and the sealing block spring 54 resets and drives the sealing block 52 to move downward. In the process of the sealing block 52 moving downward, the upper and lower guide groove 521 moves along the first upper and lower guide block 511, which can ensure the linearity of the movement of the sealing block 52. When the telescopic panel assembly 1 extends out from the telescopic inner cavity a, the force exerted by the rear wall of the telescopic panel assembly 1 on the sealing slider 53 disappears; when the sealing slider spring 55 resets and drives the sealing slider 53 to move toward the user side, the sealing slider 53 slides along the second front and rear slide grooves 512, thereby ensuring the linear movement of the sealing slider 53; the sealing block spring 54 drives the sealing block 52 to move downward, and the upper and lower guide grooves 521 move along the first upper and lower guide blocks 511, thereby ensuring the linear movement of the sealing block 52.

Please refer to FIGS. 6 and 7, in the PM2.5 measurement module of the present application, the sealing block 52 of the measurement hole sealing assembly 5 is provided with an extension plate 522 on the side facing the sealing slider 53, and the extension plate 522 is provided with a first starting block 5221. The first starting block 5221 is inclined on the side facing the sealing slider 53, and the inclined surface is inclined downward from the side away from the sealing slider 53 to the side close to the sealing slider 53. When the sealing slider 53 slides toward the user side, it acts on the first starting block 5221, causing the sealing block 52 to move upward and compress the sealing block spring 54. When the telescopic panel assembly 1 extends out from the telescopic inner cavity a, the force exerted by the rear wall of the telescopic panel assembly 1 on the sealing slider 53 disappears, and the sealing slider spring 55 resets and drives the sealing slider 53 to slide toward the user side; when the sealing slider 53 slides toward the user side, its lower surface first acts on the first starting block 5221, and cuts into it from the lowest end of the inclined surface of the first starting block 5221. In the process of the sealing slider 53 sliding toward the user side, the lower surface of the sealing slider 53 gradually approaches the higher end of the inclined surface of the first starting block 5221 and squeezes the first starting block 5221, and the sealing block 52 moves toward the sealing seat 51 and compresses the sealing block spring 54 during the movement.

Please refer to FIGS. 6 and 7, in the PM2.5 measurement module of the present application, the sealing slider 53 of the measurement hole sealing assembly 5 includes a body 531, and the body 531 is provided with a sliding connection part 532 and a starting part 533. The sliding connection part 532 is arranged at the lower end of the body 531 and is slidably connected in the second front and rear slide grooves 512. The starting part 533 is arranged above the sliding connection part 532, and a second starting block 5321 is arranged on its lower surface. The second starting block 5321 has an inclined surface on one side facing the first starting block 5221, and the inclination direction of the inclined surface on the second starting block 5321 is opposite to the inclination direction of the inclined surface on the first starting block 5221. When the telescopic panel assembly 1 extends out from the telescopic inner cavity a, the force exerted by the rear wall of the telescopic panel assembly 1 on the sealing slider 53 disappears, and the sealing slider spring 55 resets and drives the sealing slider 53 to slide toward the user side; when the sealing slider 53 slides toward the user side, the sliding connection part 532 slides along the second front and rear slide grooves 512, and the highest end of the inclined surface of the second starting block 5321 on the lower surface of the starting part 533 acts on the lowest end of the inclined surface of the first starting block 5221. In the process of the sealing slider 53 sliding toward the user side, the inclined surface of the second starting block 5321 slides along the inclined surface of the first starting block 5221 and squeezes the inclined surface of the first starting block 5221. Under the action of the second starting block 5321, the sealing block 52 moves upward and compresses the sealing block spring 54.

Please refer to FIG. 6 and FIG. 7, in the PM2.5 measurement module of the present application, second upper and lower guide blocks 5222 are provided at both sides of the extension plate 522 of the measurement hole sealing assembly 5, and upper and lower slide grooves 513 corresponding to the second upper and lower guide blocks 5222 are provided at the sealing seat 51. The second upper and lower guide blocks 5222 are slidably connected in the upper and lower slide grooves 513. When the telescopic panel assembly 1 is extended from the telescopic inner cavity a, the force exerted on the sealing slider 53 by the rear wall of the telescopic panel assembly 1 disappears, and the sealing slider spring 55 resets and drives the sealing slider 53 to slide toward the user side. When the sealing slider 53 slides toward the user side, the sliding connection part 532 slides along the second front and rear slide grooves 512, and the inclined surface of the second starting block 5321 slides along the inclined surface of the first starting block 5221 and squeezes the inclined surface of the first starting block 5221. Under the action of the second starting block 5321, the sealing block 52 moves upward, and the second upper and lower guide blocks 5222 slide along the upper and lower slide grooves 513. When the telescopic panel assembly 1 is retracted into the telescopic inner cavity a, the rear wall surface of the telescopic panel assembly 1 acts on the sealing slider 53 and drives the sealing slider 53 to slide away from the user side, and the sliding connection part 532 slides along the second front and rear slide grooves 512; the inclined surface of the second starting block 5321 retreats along the inclined surface of the first starting block 5221, and the squeezing force on the inclined surface of the first starting block 5221 gradually decreases; the sealing block spring 54 gradually resets and drives the sealing block 52 to move downward, and the second upper and lower guide blocks 5222 slide along the upper and lower slide grooves 513.

Please refer to FIGS. 6 and 7, in the PM2.5 measurement module of the present application, a sealing slider spring seat 5311 is provided at the side of the body 531 of the measurement hole sealing assembly 5 away from the first starting block 5221, and the front and rear slider springs 5 are arranged in the sealing slider spring seat 5311. When the rear wall surface of the telescopic panel assembly 1 acts on the sealing slider 53 and drives the sealing slider 53 to move on the sealing seat 51 away from the user side, the front and rear slider springs 5 are compressed; when the external force disappears, the front and rear slider springs 5 reset and drive the sealing slider 53 to move on the sealing seat 51 toward the user side. When the telescopic panel assembly 1 is extended from the telescopic inner cavity a, the force applied by the telescopic panel assembly 1 to the sealing slider 53 disappears, and the front and rear slider springs 5 are reset and drive the sealing slider 53 to move toward the user side, so that the sealing slider 53 acts on the sealing block 52; when the telescopic panel assembly 1 is retracted into the telescopic inner cavity a, the rear wall surface of the telescopic panel assembly 1 acts on the front and rear sliders 2 and pushes the sealing slider 53 to move away from the user side, and the sealing slider 53 compresses the front and rear slider springs 5, so that the front and rear slider springs 5 accumulate force, so as to drive the sealing slider 53 to reset when the telescopic panel assembly 1 is extended from the telescopic inner cavity a.

Please refer to FIGS. 6 and 7, in the PM2.5 measurement module of the present application, the sealing block 52 of the measurement hole sealing assembly 5 is provided with sealing block spring slide grooves 523 on both sides, and the sealing seat 51 is provided with a sealing block spring seat 514 corresponding to the sealing block spring slide groove 523. The sealing block spring 54 is connected to the sealing block spring seat 514, and the sealing block spring seat 514 is slidably connected to the sealing block spring slide groove 523. When the sealing slider 53 acts on the sealing block 52 and moves the sealing block 52 in the direction close to the sealing seat 51, or when the sealing slider 53 leaves the sealing block 52, the sealing block spring 54 drives the sealing block 52 to move in the direction away from the sealing seat 51, the sealing block spring slide groove 523 slides along the sealing block spring seat 514, which can ensure the linear movement of the sealing block 52; at the same time, the sealing block spring seat 514 and the sealing block spring slide groove 523 limit the sealing block spring 54, so that the sealing block spring 54 can only deform in the vertical direction and cannot be twisted and deformed.

Please refer to FIGS. 6 and 7, in the PM2.5 measurement module of the present application, a sealing block limit groove 5231 is provided at the side wall of the sealing block spring slide groove 523 of the measurement hole sealing assembly 5, and a sealing block limit block 5141 is provided at the sealing block spring seat 514. The sealing block limit block 5141 is slidably connected in the sealing block limit groove 5231. When the sealing slider 53 acts on the sealing block 52, the sealing block spring slide groove 523 slides along the sealing block spring seat 514, the sealing block limit block 5141 slides along the sealing block limit groove 5231, and the sealing block spring 54 is compressed; after the sealing slider 53 leaves the sealing block 52, the sealing block spring 54 resets, and the sealing block spring 54 pushes the sealing block 52 to move downward; the sealing block limit block 5141 limits the sealing block spring slide groove 523 through the sealing block limit groove 5231 to prevent the sealing block spring slide groove 523 from being separated from the sealing block spring seat 514.

Please refer to FIGS. 6 and 7, in the PM2.5 measurement module of the present application, a second sealing sponge 56 is provided at the side of the sealing block 52 of the measurement hole sealing assembly 5 away from the sealing seat 51. After the sealing slider 53 leaves the sealing block 52, the sealing block spring 54 resets and pushes the sealing block 52 to move downward, and the upper and lower guide grooves 521 move downward along the first upper and lower guide blocks 511 and act on the top plate of the telescopic panel assembly 1. The second sealing sponge 56 is squeezed between the sealing block 52 and the top surface of the telescopic panel assembly 1, and the gap between the sealing block 52 and the top surface of the telescopic panel assembly 1 is sealed, so that the air in the telescopic inner cavity a cannot enter the PM2.5 measurement unit 2 through the first measurement hole 11 on the top plate of the telescopic panel assembly 1.

Please refer to FIGS. 3 and 8 to 11, in the PM2.5 measurement module of the present application, the PM2.5 measurement unit 2 includes a measurement shell 21 and a PM2.5 measurement member 22 arranged in the measurement shell 21. The measurement shell 21 is provided with a measurement air intake duct 211 and a measurement air exhaust duct 212 that are independent of each other. The upper end openings of the measurement air intake duct 211 and the measurement air exhaust duct 212 abut against the top surface of the telescopic panel assembly 1 and are aligned with the first measurement hole 11. The lower end openings of the measurement air intake duct 211 and the measurement air exhaust duct 212 abut against the bottom surface of the telescopic panel assembly 1 and are aligned with the second measurement hole 12. The air intake side of the PM2.5 measurement member 22 is connected to the measurement air intake duct 211, and the exhaust side of the PM2.5 measurement member 22 is connected to the measurement air exhaust duct 212. The PM2.5 measurement module of the present application, after being used on the range hood, when the range hood is working, the telescopic panel assembly 1 extends out of the telescopic inner cavity a; at this time, the first measurement hole 11 is located outside the telescopic inner cavity a, and the second measurement hole 12 is located inside the telescopic inner cavity a; the sealing assembly 4 seals the gap between the lower surface of the telescopic panel assembly 1 and the opening of the telescopic inner cavity a. When the smoke exhaust fan of the range hood is started, the PM2.5 measurement member 22 detects the air above the telescopic panel assembly 1, and the air enters the measurement air inlet duct 211 through the part where the first measurement hole 11 is aligned with the measurement air inlet duct 211; after being detected by the PM2.5 measurement member 22, it is discharged into the measurement air exhaust duct 212 and discharged; after the smoke exhaust fan is turned off, the telescopic panel assembly 1 retracts into the telescopic inner cavity a, the measurement hole sealing assembly 5 seals the first measurement hole 11, and the measurement hole switch assembly 3 connects the third measurement hole a1 with the second measurement hole 12. After the PM2.5 measurement member 22 is started, the air outside the telescopic inner cavity a passes through the third measurement hole a1, the air intake duct 311, the air intake extension duct 321, and the second measurement hole 12 in sequence and enters the lower end opening of the measurement air inlet duct 211, then flows along the measurement air inlet duct 211 and is detected by the PM2.5 measurement member 22. After being detected by the PM2.5 measurement member 22, it is discharged into the measurement air exhaust duct 212, and then is discharged through the second measurement hole 12, the air exhaust extension duct 322, the air exhaust duct 312 and the third measurement hole a1 in sequence. After the telescopic panel assembly 1 is retracted into the telescopic inner cavity a, the measurement hole switch assembly 3 connects the third measurement hole a1 and the second measurement hole 12. The air detected by the PM2.5 measurement member 22 comes from the bottom of the telescopic inner cavity a, which is close to the air intake port of the range hood. When oil fume backflow occurs, the PM2.5 measurement unit 2 can promptly detect that the PM2.5 content in the air exceeds the standard, and enable the control system of the range hood to promptly start the smoke exhaust fan.

In the PM2.5 measurement module of the present application, the driving assembly 8 can adopt an electric push rod; the driving end of the electric push rod is connected to the telescopic panel assembly 1, and the two side walls of the telescopic inner cavity a are provided with slide rail assemblies. The two sides of the telescopic panel assembly 1 are connected to the movable rails of the slide rail assembly. When the electric push rod is started, the telescopic panel assembly 1 slides along the guide rail assembly in the telescopic inner cavity.

In an embodiment, the driving assembly 8 of the PM2.5 measurement module of the present application can also adopt the method of a motor driving a screw; the driving end of the motor is connected to the screw; a nut is connected to the screw; the nut is connected to the telescopic panel assembly 1, and the two side walls of the telescopic inner cavity a are provided with slide rail assemblies; the two sides of the telescopic panel assembly 1 are connected to the movable rails of the slide rail assembly. When the motor is started, the screw rotates, and the screw nut slides along the screw and drives the telescopic panel assembly 1 to slide along the guide rail assembly in the telescopic inner cavity.

Please refer to FIGS. 1, 8 and 9, the present application also discloses a range hood. The range hood disclosed in the present application adopts the above-mentioned PM2.5 measurement module. An air collecting box assembly 9 is also provided in the main body. A smoke exhaust fan 91 is provided in the air collecting box assembly 9. The smoke exhaust fan 91, the PM2.5 measurement unit 2 and the driving assembly 8 are connected to the control system of the range hood. The control system links the smoke exhaust fan 91 and the PM2.5 measurement unit 2. When the range hood is working, the smoke exhaust fan 91 of the range hood is started; at the same time, the driving assembly 8 is started and drives the telescopic panel assembly 1 to extend out of the telescopic inner cavity a; the first measurement hole 11 extends out of the telescopic inner cavity a; the sealing assembly 4 seals the gap between the telescopic panel assembly 1 and the opening of the telescopic inner cavity a; the connecting duct between the third measurement hole a1 and the second measurement hole 12 is sealed by the measurement hole switch assembly 3. The oil smoke generated by cooking cannot enter the telescopic inner cavity through the gap between the telescopic panel assembly 1 and the opening of the telescopic inner cavity a, and the oil smoke cannot enter the second measurement hole 12 through the third measurement hole a1. The air detected by the PM2.5 measurement unit 2 is the air above the telescopic panel assembly 1. The PM2.5 content value in the air represents the escape of oil smoke when the smoke exhaust fan is started, and can truly feedback the purification effect of the smoke exhaust fan on oil smoke. When the PM2.5 measurement unit 2 is linked with the control system of the range hood, the control system of the range hood can adjust the power of the smoke exhaust f an according to the PM2.5 content value detected by the PM2.5 measurement unit 2. After cooking is finished and the smoke exhaust fan 91 is turned off, the driving assembly 8 drives the telescopic panel assembly 1 to retract into the telescopic inner cavity a, and the measurement hole sealing assembly 5 seals the first measurement hole 11 on the top of the telescopic panel assembly 1. The measurement hole switch assembly 3 connects the third measurement hole a1 with the second measurement hole 12, and the air below the telescopic inner cavity a enters the second measurement hole 12 through the third measurement hole a1, the air intake duct 311, and the air intake extension duct 321, and then enters the measurement air inlet duct 211 from the second measurement hole 12; after being detected by the PM2.5 measurement member 22, it is discharged into the measurement air exhaust duct 212, and then enters the air exhaust extension duct 322 and the air exhaust duct 312 in turn through the second measurement hole 12, and is finally discharged from the third measurement hole a1.

The above descriptions are only some embodiments of the present application, and does not limit the patent scope of the present application. All equivalent structural transformations made by configuring the contents of the present application specification and drawings under the technical concept of the present application, or directly/indirectly applied in other related technical fields, are included in the patent protection scope of the present application.

What is claimed is:

1. A particulate matter (PM) 2.5 measurement module, applied to a range hood, comprising:
a main body, comprising a frame assembly and a cover assembly, wherein the frame assembly and the cover assembly are connected to form a telescopic inner cavity, and a third measurement hole is provided at a bottom of the frame assembly;
a telescopic panel assembly, slidably connected in the telescopic inner cavity, wherein a first measurement hole is provided at a top of the telescopic panel assembly, and a second measurement hole is provided at a bottom of the telescopic panel assembly;
a PM2.5 measurement unit, provided at an installation cavity of the telescopic panel assembly; and
a driving assembly, provided in the telescopic inner cavity, wherein the driving assembly is connected to the telescopic panel assembly and configured to drive the telescopic panel assembly to extend out of or retract into the telescopic inner cavity;
wherein when the telescopic panel assembly extends out of the telescopic inner cavity, the PM2.5 measurement unit is connected to an outside through the first measurement hole; and
when the telescopic panel assembly is retracted into the telescopic inner cavity, the PM2.5 measurement unit is communicated with the third measurement hole through the second measurement hole, and the third measurement hole is communicated with the outside.

2. The PM2.5 measurement module according to claim 1, wherein when the telescopic panel assembly extends out of the telescopic inner cavity, the third measurement hole is sealed, and the second measurement hole is sealed in the telescopic inner cavity; and
when the telescopic panel assembly retracts into the telescopic inner cavity, the first measurement hole is sealed, the second measurement hole is communicated with the third measurement hole, and the third measurement hole is communicated with the outside.

3. The PM2.5 measurement module according to claim 1, wherein a measurement hole switch assembly is provided in the telescopic inner cavity;
when the telescopic panel assembly extends out of the telescopic inner cavity, the measurement hole switch assembly seals the third measurement hole; and
when the telescopic panel assembly retracts into the telescopic inner cavity, the measurement hole switch assembly opens the third measurement hole and communicates the third measurement hole with the second measurement hole.

4. The PM2.5 measurement module according to claim 3, wherein the measurement hole switch assembly comprises a switch seat, an extension seat, a switch slider, and an extension seat spring; the switch seat is provided with an air duct aligned with the third measurement hole; the extension seat is provided with an extension air duct sleeved with the air duct; the extension seat spring is provided between the extension seat and the switch seat; a switch slider spring is connected to a rear end of the switch slider;
when the switch slider acts on the extension seat and seals the air duct, the extension seat spring is compressed; and
when the switch slider leaves the extension seat and opens the air duct, the switch slider spring is compressed, and the extension seat spring resets and drives the extension seat to move upward.

5. The PM2.5 measurement module according to claim 4, wherein the air duct comprises an air inlet duct and an air exhaust duct, and the air inlet duct and the air exhaust duct are both aligned with the third measurement hole at the same time; the extension air duct comprises an air inlet extension duct sleeved with the air inlet duct and an air exhaust extension duct sleeved with the air exhaust duct; and
when the telescopic panel assembly retracts into the telescopic inner cavity and presses the switch slider backward, the switch slider leaves the extension seat and opens the air inlet duct and the air exhaust duct, and the extension seat spring resets and drives the air inlet extension duct and the air exhaust extension duct to slide upward along the air inlet duct and the air exhaust duct and abut against the second measurement hole.

6. The PM2.5 measurement module according to claim 1, further comprising a sealing assembly, wherein the first measurement hole is located at a front side of the sealing assembly, and the second measurement hole is located at a rear side of the sealing assembly; and the sealing assembly is configured for sealing at least a gap between a lower surface of the telescopic panel assembly and an opening of the telescopic inner cavity when the telescopic panel assembly extends out of the telescopic inner cavity.

7. The PM2.5 measurement module according to claim 1, wherein a measurement hole sealing assembly is provided in the telescopic inner cavity, and when the telescopic panel assembly is retracted into the telescopic inner cavity, the measurement hole sealing assembly seals the first measurement hole.

8. The PM2.5 measurement module according to claim 7, wherein the measurement hole sealing assembly comprises a sealing seat, a sealing block, and a sealing slider; the sealing seat is connected to a top of the telescopic inner cavity; the sealing block is connected to the sealing seat by sliding up and down; a sealing block spring is provided between the sealing block and the sealing seat; the sealing slider is connected to the sealing seat by sliding forward and backward; a sealing slider spring is connected to a rear end of the sealing slider;
when the sealing slider acts on the sealing block, the sealing block spring is compressed; and
when the sealing slider leaves the sealing block, the sealing slider spring is compressed, and the sealing block spring resets and pushes the sealing block to move downward.

9. The PM2.5 measurement module according to claim 1, wherein the PM2.5 measurement unit comprises a measurement shell and a PM2.5 measurement member arranged in the measurement shell; the measurement shell is provided with a measurement air intake duct and a measurement air exhaust duct independent of each other; upper end openings of the measurement air intake duct and the measurement air exhaust duct are abutted against a top surface of the telescopic panel assembly and aligned with the first measurement hole; lower end openings of the measurement air intake duct and the measurement air exhaust duct are abutted against a bottom surface of the telescopic panel assembly and aligned with the second measurement hole; an air intake side of the PM2.5 measurement member is in communication with the measurement air intake duct; and an air exhaust side of the PM2.5 measurement member is in communication with the measurement air exhaust duct.

10. A range hood, comprising the PM2.5 measurement module according to claim 1, wherein an air collecting box assembly is further provided in the main body, and a smoke exhaust fan is provided in the air collecting box assembly; the smoke exhaust fan, the PM2.5 measurement unit, and the driving assembly are connected to a control system of the range hood, and the control system enables the smoke exhaust fan and the PM2.5 measurement unit to operate in linkage.
